(19) United States
(12) Patent Application Publication
(10) Pub. No.: US 2026/0361666 A1
(43) Pub. Date: Nov. 12, 2026

(54) MANAGED SINGLE PAIR ETHERNET SWITCH

(71) Applicant: Bel Fuse Inc., Wheeling, IL (US)

(72) Inventor: Luis Torres, Palatine, IL (US)

(21) Appl. No.: 19/672,565

(22) Filed: May 9, 2026

Related U.S. Application Data
(60) Provisional application No. 63/803,352, filed on May 9, 2025.

(51) Int. Cl. H04L 49/40; H04L 12/44; H04L 25/02

(52) U.S. Cl. CPC H04L 49/40; H04L 12/44; H04L 25/0272; H04L 2012/445

(57) ABSTRACT

A networking apparatus comprising a first electronics subsystem for delivering managed power to the Single Pair Ethernet line interfaces and a second electronics subsystem comprising a plurality of SPE line interfaces and a third electronics subsystem comprising a switch matrix (fabric), and an applications (network) processor that presides over the configuration and management of the networking apparatus and supporting resources such as memory for the network processor.

### RELATED APPLICATIONS

This application claims benefit of priority to Provisional U.S. Patent Application No. 63/803,352, filed May 9, 2025; the aforementioned priority application being hereby incorporated by reference in its entirety.

### TECHNICAL FIELD

The invention relates to a networking apparatus, and more specifically, to a Managed Single Pair Ethernet (SPE) switch matrix.

### BRIEF DESCRIPTION OF THE DRAWINGS

FIG. 1 provides a block diagram describing the present invention (100);

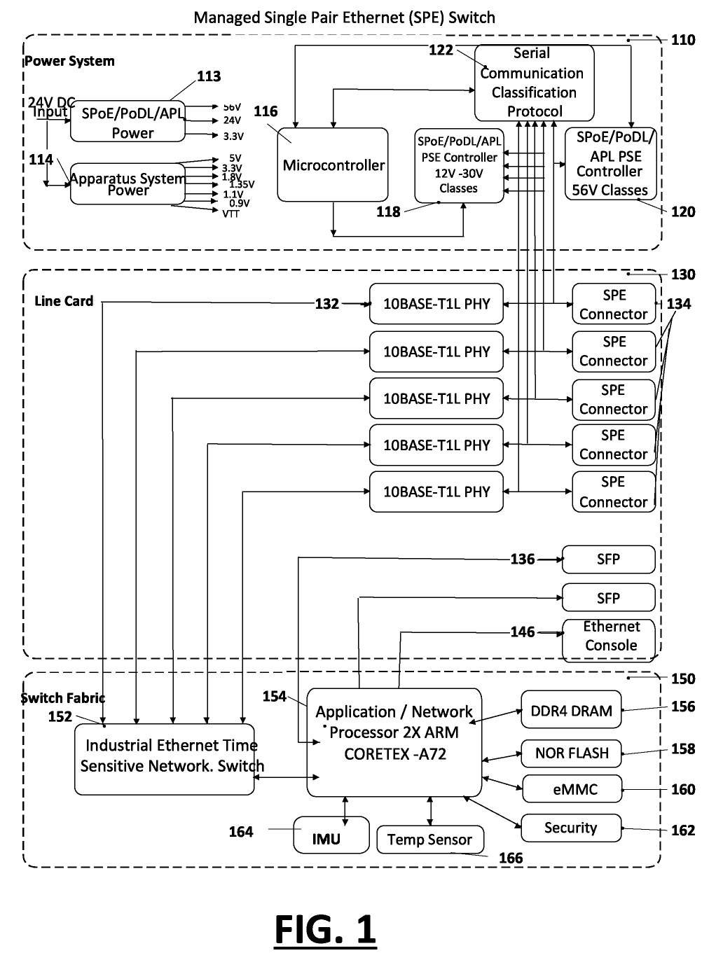

FIG. 2 is a plan view of the connector face of a first embodiment of the networking apparatus (100) having three-pin terminal block Single Pair Ethernet (SPE) connectors; and

FIG. 3 is an end view of the first embodiment of FIG. 2;

FIG. 4 is a plan view of the connector face of a second embodiment of the networking apparatus (100) having IEC 63171-7 SPE connectors;

FIG. 5 is an end view of the second embodiment of FIG. 4;

FIG. 6 is a plan view of the connector face of a third embodiment of the networking apparatus (100) having IEC 63171-2 SPE connectors;

FIG. 7 is an end view of the third embodiment of FIG. 6;

FIG. 8 is a plan view of the connector face of a fourth embodiment of the networking apparatus (100) having IEC 63171-6 SPE connectors; and

FIG. 9 is an end view of the fourth embodiment of FIG. 8.

### DETAILED DESCRIPTION

The present invention pertains to a networking apparatus ( 100) comprising a first electronics subsystem (110) for delivering managed power to Single Pair Ethernet (SPE) line interfaces, a second electronics subsystem (130) comprising a plurality of SPE line interfaces, and a third electronics subsystem (150) comprising a switch matrix (152) (fabric), and an applications, or network, processor (154) configured to preside over the configuration, control, and management of the networking apparatus together with supporting memory resources (156,158, 160) for the network processor and software applications.

The networking apparatus (100) is configured to support IEEE 802.3cg compliant 10BASE-T1L communication over single balanced twisted pair cabling and further supports the delivery of electrical power over the same cabling infrastructure. The apparatus(100) is capable of delivering managed power (116, 118, 120, 122) using Single Pair Power over Ethernet (SPoE), known also as Power over Data Line (PoDL), and Ethernet-Advanced Physical Layer (Ethernet-APL) power delivery techniques.

The first electronic subsystem (110) for delivering managed power further comprises optional redundant auxiliary DC input power connectors (112) and a power conversion architecture (113, 114) for generating regulated internal operating voltages together with managed power supplied to the SPE line interfaces. The power conversion subsystem (113, 114) further comprises electrical isolation between the auxiliary DC input power domain and the managed SPE or Ethernet-APL output power domain delivered to connected field devices. The first electronics subsystem (110) further comprises an embedded microcontroller (116) for configuring and managing the power delivered to the plurality of SPE line interfaces (132, 134).

In one embodiment, the apparatus (100) supports multiple managed SPE power classes and multiple Ethernet-APL power classes suitable for powering field devices in non-intrinsically safe and non-explosive industrial environments. The apparatus (100) may deliver approximately 24V or 56V managed power for conventional SPE devices and approximately up to 60V managed power for Ethernet-APL field devices operating in APL Class X configurations. Managed power delivery is controlled through an embedded microcontroller (116) and dedicated power management circuitry (118, 120, 122) configured to monitor startup sequencing, current limiting, overload conditions, short-circuit protection, and per-port power allocation.

The second electronic subsystem (SPE line interface) (130) subsystem further comprises power coupling and power splitting circuitry (132) configured to combine and separate communication data and managed power delivered over the single twisted pair cabling connected to the plurality of SPE line interfaces (132, 134). The line interface subsystem further comprises physical layer (PHY) devices (132) compliant with IEEE 802.3cg 10BASE-T1L specifications and optional Ethernet-APL operating modes. The plurality of SPE line interfaces (134) may comprise optional connectors including, but not limited to, terminal block connectors (134a), IEC 63171 compliant SPE connectors(134, 134c) or other industrial connector systems suitable for field-level industrial networking applications, and a plurality of connections between the SPE line interface channel PHY devices (132) and the switch matrix (152).

The third electronic subsystem (150) further comprises a switch fabric (or switch matrix) subsystem (150) interconnected to the plurality of SPE PHY devices (132) and the network or applications processor (154). The switch matrix (152) supports packet forwarding, traffic management, VLAN functionality, multicast management, and Time Sensitive Networking (TSN) features to provide deterministic and low-latency communication suitable for industrial automation applications. Furthermore, the networking apparatus (100) further comprising a switch matrix (152) that supports a variety of common industrial protocols including, but not limited to, PROFINET, EtherNetI/P, EtherCAT and Modbus/TCP.

The application, or network, processor (154) hosts an operating system comprising an open-source Linux-based operating system including, but not limited to, OpenWRT or other embedded Linux distributions. The operating system supports configuration, monitoring, diagnostics, cybersecurity features, protocol management, and application-specific customization of the networking apparatus. Supporting resources for the applications processor further comprise DRAM memory (156), FLASH memory (158), NOR flash memory (158), and non-volatile eMMC storage (160) for operating system images, application software, configuration files, and utility functions. A security element (162), an inertial measurement unit (164) and a temperature sensor (166) are further provided as peripherals to the network processor (154).

The second electronic subsystem (130) further comprises one or more Small Form-Factor Pluggable (SFP) interfaces (136) configured to support uplink connectivity, switch expansion, or media conversion through interchangeable transceiver modules. The interfaces may support copper Ethernet, fiber optic Ethernet, or additional SPE interfaces. The apparatus may further comprise management interfaces (146) Including USB, RJ45 Ethernet management ports, serial console interfaces, or wireless management connectivity connected to the embedded network processor (154) to serve as a console interface through which an operator can log in to the networking apparatus OS for configuring and managing the networking apparatus.

In one embodiment, the networking apparatus (100) comprises two AUX DC power inputs (112) for redundancy protection however a single AUX DC power input (144) embodiment is also contemplated within the scope of the invention.

The first electronics subsystem (110) further comprises a controller (118, 120) for managing the power to the requirements of the IEEE 802.3cg standard wherein the managed power can optionally be defined as Single Pair Power Over Ethernet (SPoE) or Power Over Data Line (PoDL) in that both SPoE and PoDL refer to power delivered differentially over a single twisted pair together with SPE data, communicated between the controllers (118, 120) and the PHY electronics (132) over a Serial Communication Classification Protocol bus (122). The first electronics subsystem (110) further comprises separate SPoE or PoDL controllers, one each for 24V DC Class 10-12 SPE power (118) and 55V DC Class 13-15 SPE power (120).

The first electronics subsystem (110) comprising of controllers (118, 120) and microcontroller (116) for managing power delivery may further support Ethernet-APL field device connectivity whereby managed power and Ethernet communication are simultaneously delivered over single twisted pair cabling to Ethernet-APL compatible field instruments, sensors, actuators, controllers, and industrial automation devices. In one embodiment, the apparatus supports Ethernet-APL Class X operation for deployment in non-intrinsically safe and non-explosive industrial environments where higher managed power levels may be utilized.

The physical layer or PHY electronics (132) for conditioning data for transmission over single twisted pair cabling connected to the plurality of SPE line interfaces are compliant with the SPE specifications defined in the IEEE 802.3cg standard for 10BASE-T1L. The apparatus (100) includes 8-ports arranged as 5-ports dedicated for 10BASE-T1L SPE connections, 2-ports implemented as Small Form-Factor Pluggable (SFP) cages (136) for expansion or uplink connectivity and 1-port implemented as a 10/100/1000 Ethernet port (146) with an RJ45 connector for management console connection.. The 5-ports dedicated for 10BASE-T1L SPE connections and 2-ports implemented as Small Form-Factor Pluggable (SFP) cages for expansion or uplink connectivity all support Time Sensitive Networking or TSN to provide predictable and low-latency communication for real-time applications. The apparatus Operating System or OS is based on an open-source Linux OS such,but not limited to, OpenWRT to allow users to customize the features, functions, and utility of the apparatus for specific application requirements. Other port counts and interface combinations are contemplated within the scope of the invention.

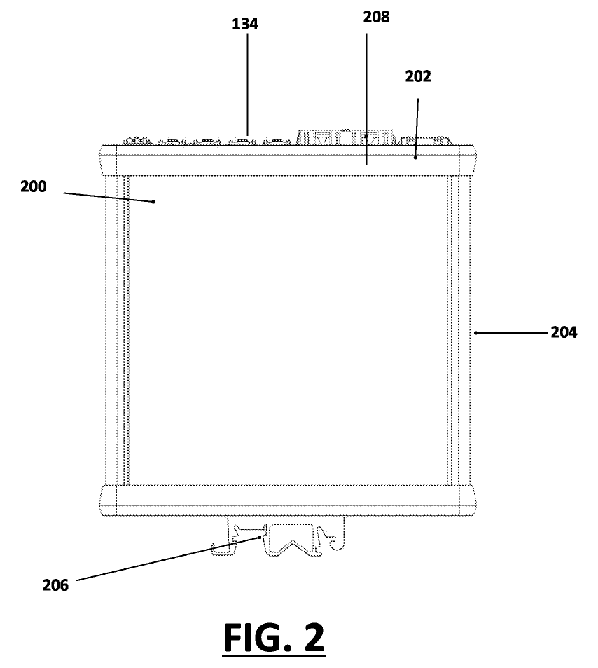

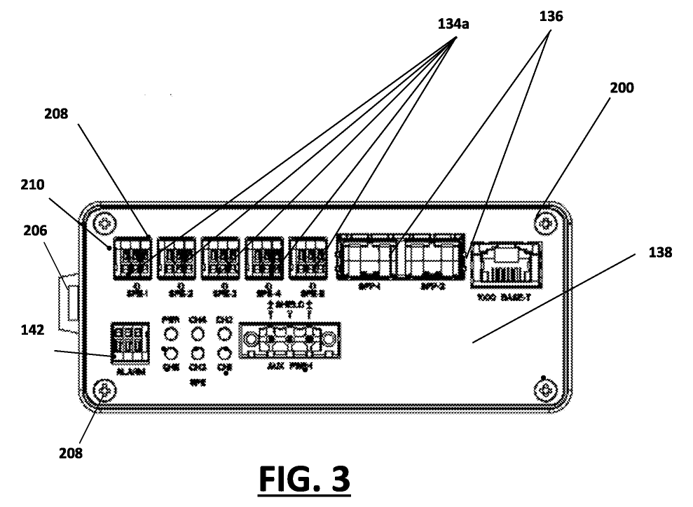

Referring to FIGS. 2 and 3, a first embodiment of the networking apparatus (100) is illustrated. The networking apparatus (100) is enclosed within a metal housing (200) comprising a top cover (202), an extruded side-rail body (204), a DIN-rail mounting clip (206) on a rear surface thereof, and a front end plate (208) retained by mounting screws (210). The front end plate (208) of the first embodiment carries an alarm connector (142); five SPE line interfaces (134), each implemented as a three-pin terminal block connector (134a) having a positive (+) terminal, a shield terminal, and a negative (-) terminal; a single auxiliary DC power connector (112) labeled AUX PWR-1; two SFP cages (136) labeled SFP-1 and SFP-2; and an RJ45 1000BASE-T management port (146). A power indicator LED (144) and a plurality of channel status LEDs (144), one each for SPE channels CH1 through CH5, are also visible on the front end plate (208).

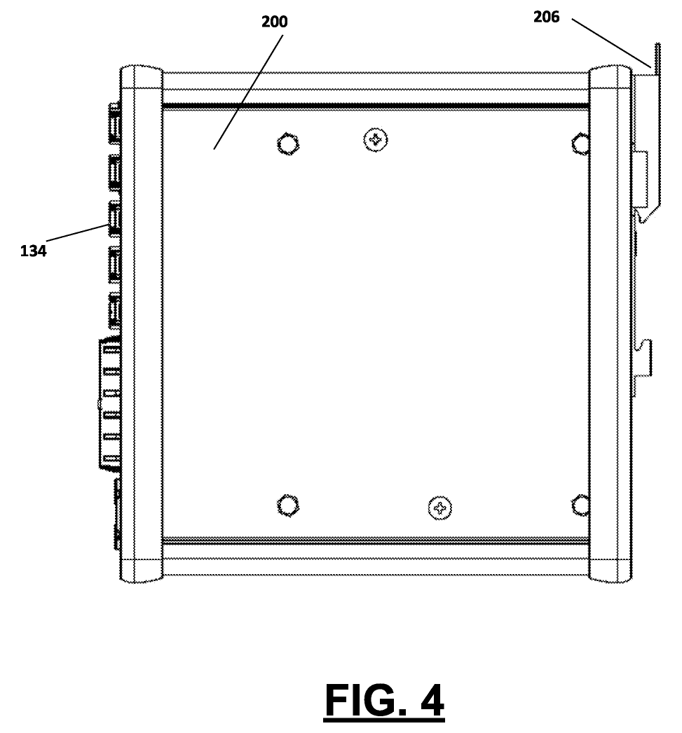

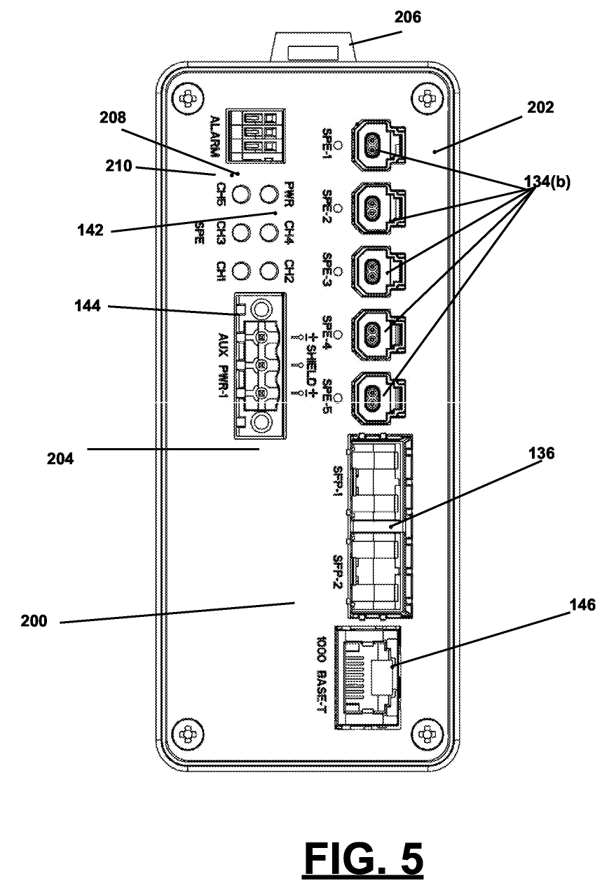

Referring to FIGS. 4 and 5, a second embodiment of the networking apparatus (100) is illustrated. The second embodiment is substantially identical in form factor and feature set to the first embodiment, except that each of the five SPE line interfaces (134) is implemented as an IEC 63171-7 SPE connector (134b) in place of the three-pin terminal block connector (134a) of the first embodiment.

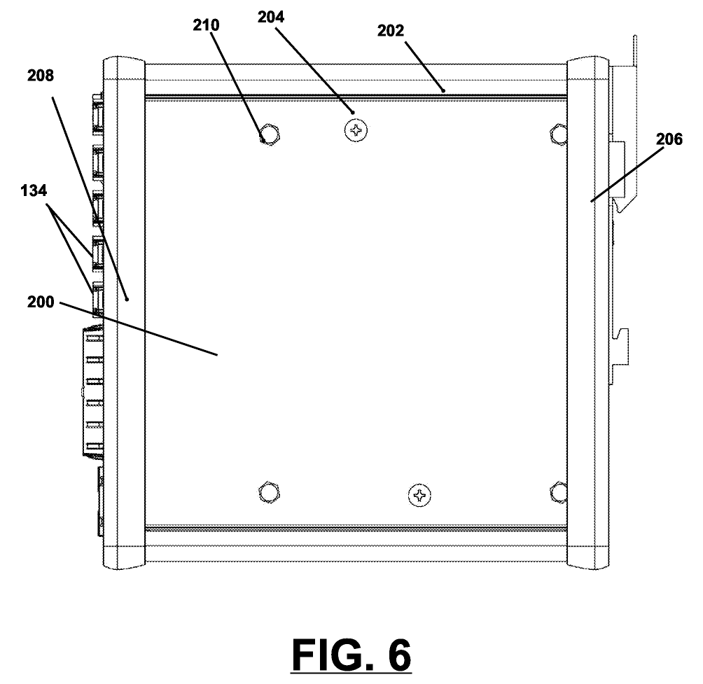

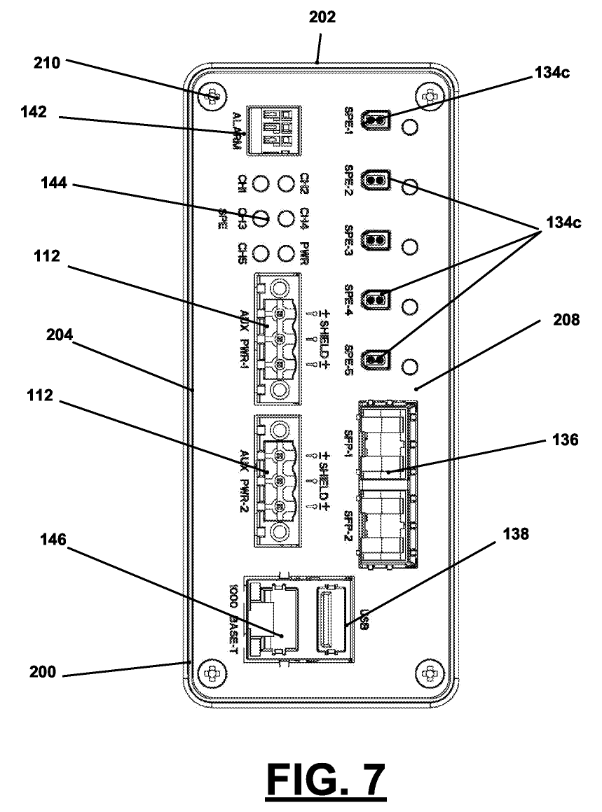

Referring to FIGS. 6 and 7, a third embodiment of the networking apparatus (100) is illustrated. The third embodiment is enclosed within a metal housing (200) of larger form factor than the housing (200) of the first and second embodiments, the housing (200) of the third embodiment similarly comprising a top cover (202), an extruded side-rail body (204), a DIN-rail mounting clip (206) on a rear surface thereof, and a front end plate (208) retained by mounting screws (210). Each of the five SPE line interfaces (134) is implemented as an IEC 63171-2 SPE connector (134c). The front end plate (208) of the third embodiment carries an alarm connector (142); the five SPE line interfaces (134); a redundant pair of auxiliary DC power connectors (112), labeled AUX PWR-1 and AUX PWR-2 respectively; two SFP cages (136) labeled SFP-1 and SFP-2; an RJ45 1000BASE-T management port (146); and a USB port (138) for management console connection. A power indicator LED (144) and a plurality of channel status LEDs (144), one each for SPE channels CH1 through CH5, are also visible on the front end plate (208).

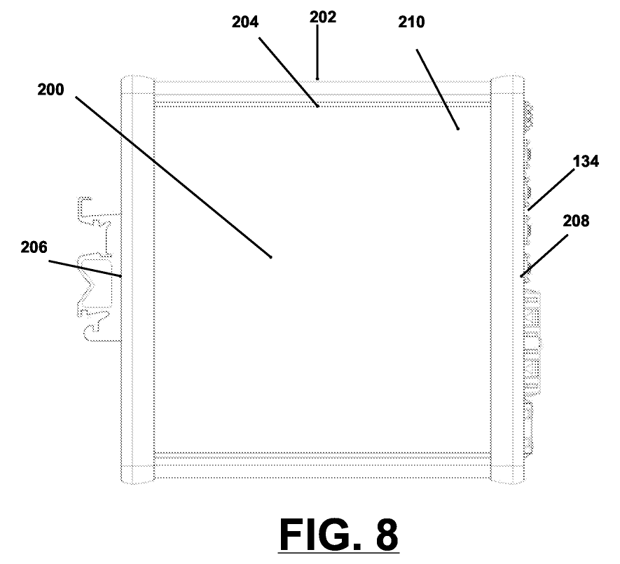

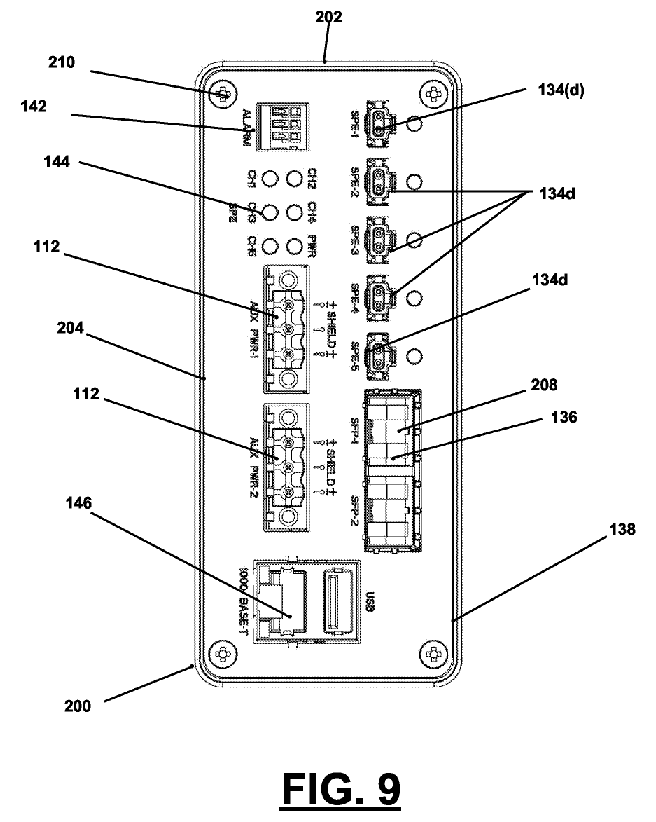

Referring to FIGS. 8 and 9, a fourth embodiment of the networking apparatus (100) is illustrated. The fourth embodiment is substantially identical in form factor and feature set to the third embodiment, except that each of the five SPE line interfaces (134) is implemented as an IEC 63171-6 SPE connector (134d) in place of the IEC 63171-2 SPE connector (134c) of the third embodiment.

The present description is a description of multiple embodiments of the present invention and those of skill in the art understand the broader scope of the invention as covered by the allowed claims of this patent.

What is claimed is:

1. A networking apparatus comprising:
a first electronics subsystem for delivering managed power to Single Pair Ethernet (SPE) line interfaces;
a second electronics subsystem comprising a plurality of SPE line interfaces;
a third electronics subsystem comprising a switch matrix (fabric); and
an applications (network) processor that presides over configuration and management of the networking apparatus and supporting resources such as memory for the network processor.

2. The networking apparatus of claim 1 wherein the first subsystem for delivering managed power to the SPE line interfaces further comprises:
a pair of connector interfaces in a redundant configuration for Auxiliary DC input power;
a transformer architecture for converting the Auxiliary DC input to regulated power supplies needed for the networking apparatus to operate and to provide managed SPE power;
the transformer architecture isolating the Auxiliary DC input power from the managed power delivered to the SPE line interfaces; and
an embedded microcontroller for configuring and managing the power delivered to the plurality of SPE line interfaces.

3. The networking apparatus of claim 1 wherein the second electronics SPE line interface subsystem further comprises:
the power splitter electronics for combining and separating managed power and data delivered at the plurality of SPE line interfaces;
physical layer or PHY electronics for conditioning data for transmission over single twisted pair cabling connected to the plurality of SPE line interfaces, the plurality of SPE line interfaces having optional connectors including:
a terminal block connector, an IEC 63171-2 connector, an IEC 63171-6 connector, or an IEC 63171-7 connector as defined by the IEC 63171 family of standards; and
a plurality of connections between the SPE line interface channel PHY devices and the switch matrix.

4. The networking apparatus of claim 1 wherein the third electronics subsystem comprising the switch fabric further comprises:
a switch matrix connected to the network processor for configuration, control and management of the switch fabric;
the embedded network processor hosts an operating system (OS) for the networking apparatus;
DRAM for supporting the embedded network processor;
FLASH memory for supporting the embedded network processor, NOR flash memory for supporting the embedded network processor; and
eMMC memory used to provide a hard drive for storage of the OS and additional utility features and functions and other applications.

5. The networking apparatus of claim 1 wherein the second electronics SPE line interface subsystem further comprises:
at least one Small Form-Factor Pluggable (SFP) cage when populated with a corresponding SFP transceiver module, capable of being utilized as an uplink to a remote networking server or as an expansion port capable of supporting an additional SPE line interface;
a USB interface connected to the embedded network processor to serve as a console interface through which an operator can log in to the networking apparatus OS for configuring and managing the networking apparatus.

6. The networking apparatus of claim 1 wherein the first electronics subsystem for delivering managed power to the SPE line interfaces further comprises:
a controller for managing the power to the requirements of IEEE 802.3cg standard, the managed power defined as Single Pair Power Over Ethernet (SPoE) or Power Over Data Line (PoDL), both SPoE and PoDL refer to power delivered differentially over a single twisted pair together with SPE data.

7. The networking apparatus of claim 1 wherein the first electronics subsystem for delivering managed power to the SPE line interfaces further comprises:
separate SPoE or PoDL controllers, one each for 24V DC Class 10-12 SPE power and 55V DC Class 13-15 SPE power.

8. The networking apparatus of claim 1 wherein the physical layer or PHY electronics for conditioning data for transmission over single twisted pair cabling connected to the plurality of SPE line interfaces are compliant with the SPE specifications defined in IEEE 802.3cg for 10BASE-T1L.

9. The networking apparatus of claim 1 wherein the apparatus includes:
55-ports dedicated for 10BASE-T1L SPE connections;
22-ports are implemented as Small Form-Factor Pluggable (SFP) cages for expansion or uplink connectivity;
11-port is implemented as a 10/100/1000 Ethernet port with an RJ45 connector for management console connection; and
11-port is implemented as a USB port for management console connection.

10. The networking apparatus of claim 1 wherein the 5-ports dedicated for 10BASE-T1L SPE connections and 2-ports implemented as Small Form-Factor Pluggable (SFP) cages for expansion or uplink connectivity all support Time Sensitive Networking or TSN, to provide predictable and low-latency communication for real-time applications.

11. The networking apparatus of claim 1 wherein the apparatus Operating System or OS is based on an open-source Linux OS such as OpenWRT to allow users to customize the features, function and utility of the apparatus for specific application requirements.

12. A managed SPE switch comprising:
a first electronics subsystem for delivering managed power to Single Pair Ethernet (SPE) line interfaces;
a second electronics subsystem comprising a plurality of SPE line interfaces;
a third electronics subsystem comprising a switch matrix; and
an applications processor for configuration and management of the switch and supporting resources including memory for the applications processor capable of delivering managed power using Single Pair Power over Ethernet (SPoE), or Power over Data Line (PoDL), and Ethernet-Advanced Physical Layer (Ethernet-APL) power delivery techniques.

13. The managed SPE switch of claim 12 wherein the first electronic subsystem is capable of delivering managed power to Advanced Physical Layer (APL) field devices in addition to Ethernet communication over the same single twisted pair, including support for higher power delivery classes suitable for non-intrinsically safe and non-explosive industrial environments.

14. The managed SPE switch of claim 12 wherein the plurality of SPE line interfaces comprises connectors compliant with the IEC 63171-2 standard.

15. The managed SPE switch of claim 12 wherein the plurality of SPE line interfaces comprises connectors compliant with the IEC 63171-6 standard.

16. The managed SPE switch of claim 12 wherein the plurality of SPE line interfaces comprises connectors compliant with the IEC 63171-7 standard.

17. The managed SPE switch of claim 12 further comprising a housing having a DIN rail mounting feature on a rear surface thereof and a connector face on a front surface thereof, the plurality of SPE line interfaces, the at least one Small Form-Factor Pluggable (SFP) cage, the 10/100/1000 Ethernet port, and an alarm connector being arranged on the connector face.
